(19) United States
(12) Patent Application Publication
(10) Pub. No.: US 2024/0387119 A1
(43) Pub. Date: Nov. 21, 2024

(54) CIRCUIT BREAKER

(71) Applicant: Siemens Aktiengesellschaft, München (DE)

(72) Inventor: Marvin Tannhäuser, Hausen (DE)

(21) Appl. No.: 18/696,503

(22) PCT Filed: Sep. 12, 2022
(86) PCT No.: PCT/EP2022/075255

§ 371 Date: Mar. 28, 2024

(30) Foreign Application Priority Data
Sep. 28, 2021 (DE) 10 2021 210 819.9

(51) Int. Cl. H01H 9/54; H01H 71/04; H01H 71/52; H01H 71/64; H01H 83/20

(52) U.S. Cl. CPC H01H 9/548; H01H 9/547; H01H 71/526; H01H 71/64; H01H 71/04; H01H 2071/044; H01H 83/20; H01H 2083/201

(57) ABSTRACT

A circuit breaker protects an electric low-voltage circuit and has: a) a mechanical separating contact unit which is connected to an electronic interruption unit in series, the mechanical separating contact unit has a handle for opening a contact in order to prevent a current flow or for closing the contact for a current flow in the low-voltage circuit; and b) a controller which is connected to the mechanical separating contact unit and the electronic interruption unit. The circuit breaker is configured such that a process for interrupting the current flow in the low-voltage circuit by the mechanical separating contact unit and/or the electronic interruption unit is initiated if current thresholds or current/time thresholds are exceeded. The circuit breaker is also configured such that the contact of the mechanical separating contact unit can be closed by the handle only after a release signal for closing the contact is provided.

The invention relates to the technical field of a circuit breaker for a low-voltage circuit having a mechanical break contact unit and an electronic interrupt unit.

Low voltage means voltages of up to 1000 volts alternating voltage or up to 1500 volts direct voltage. Low voltage in particular means voltages which are greater than the small voltage, with values of 50 volts alternating voltage or 120 volts direct voltage. The alternating voltage values mentioned mean effective values.

Low-voltage circuit or grid or system means circuits with nominal currents or rated currents of up to 125 amperes, more specifically up to 63 amperes. Low-voltage circuit in particular means circuits with nominal currents or rated currents of up to 50 amperes, 40 amperes, 32 amperes, 25 amperes, 16 amperes or 10 amperes. The current values mentioned in particular mean nominal, rated or/and interrupting currents, i.e. the current which is normally carried at maximum via the circuit or at which the electrical circuit is usually interrupted, for example by means of a protective device, such as a circuit breaker, line protection circuit breaker or power circuit breaker. The nominal currents can further be graded from 0.5 A via 1 A, 2 A, 3 A, 4 A, 5 A, 6 A, 7 A, 8 A, 9 A, 10 A, etc. up to 16 A.

Line protection circuit breakers are overcurrent protective devices that have been known for a long time, which are used in low-voltage circuits in electrical installation technology. These protect lines from damage due to heating as a consequence of excessive current and/or short circuit. A line protection circuit breaker can automatically interrupt the circuit in the case of overload and/or short circuit. A line protection circuit breaker is a safety element that does not reset automatically.

Power circuit breakers are, in contrast to power circuit breakers, provided for currents greater than 125 A, in some cases also even from 63 amperes. Line protection circuit breakers are therefore of simpler and more delicate design. Line protection circuit breakers usually have a fastening option for fastening to what is known as a top-hat rail (mounting rail, DIN rail, TH35).

Line protection circuit breakers are electromechanically constructed. In a housing, they have a mechanical switching contact or shunt release for interrupting (tripping) the electric current. Usually, a bimetal protective element or bimetal element is used for tripping (interruption) in the case of longer-lasting overcurrent (overcurrent protection) or in the case of thermal overload (overload protection). An electromagnetic trigger having a coil is used for short-term tripping in the event of an overcurrent limit value being exceeded or in the event of a short circuit (short circuit protection). One or more arc quenching chamber(s) or devices are provided for arc quenching. Further, connector elements for wires of the electrical circuit to be protected.

Circuit breakers having an electronic interrupt unit are relatively novel developments. These have a semiconductor-based electronic interrupt unit. That is to say, the electrical current flow of the low-voltage circuit is carried via semiconductor components or semiconductor switches which can interrupt the electrical current flow or be turned-on. Circuit breakers having an electronic interrupt unit further frequently have a mechanical break contact system, particularly having disconnector properties according to relevant standards for low-voltage circuits, wherein the contacts of the mechanical break contact system are connected in series to the electronic interrupt unit, i.e. the current of the low-voltage circuit that is to be protected is carried both via the mechanical break contact system and via the electronic interrupt unit.

The object of the present invention is to improve a circuit breaker r of the type mentioned in the introduction, particularly to increase the safety for a circuit breaker of this type.

This object is achieved by a circuit breaker having the features of patent claim 1.

According to the invention, a circuit breaker for protecting an electrical low-voltage circuit, particularly low-voltage AC circuit, is proposed, having:
a mechanical break contact unit which is connected in series with an electronic interrupt unit, wherein the mechanical break contact unit has a handle for opening at least one contact for avoiding a current flow or closing the at least one contact for a current flow in the low-voltage circuit,
a control unit which is connected to the mechanical break contact unit and the electronic interrupt unit, wherein the circuit breaker is designed in such a manner that interruption of the current flow in the low-voltage circuit is initiated by the mechanical break contact unit or/and the electronic interrupt unit when current or current/time limit values are exceeded.

According to the invention, the circuit breaker is configured in such a manner that the at least one contact of the mechanical break contact unit can only be closed by the handle if an approval signal for closing the at least one contact is present.

Thus, it is ensured according to the invention that the at least one contact (or the break contacts) can only be closed by manual actuation if an approval signal, particularly from the control unit, is present. The approval signal is in particular only output if the circuit breaker, particularly the control unit or the electronic interrupt unit, is active and operational. That is to say, a current flow in the low-voltage circuit by closing the contact is only enabled if the circuit breaker can (actively) carry out its protective functions.

Advantageous embodiments of the invention are specified in the subordinate claims and in the exemplary embodiment.

In an advantageous embodiment of the invention, the mechanical break contact unit is connected to a load-side terminal and the electronic interrupt unit is connected to a grid-side terminal of the circuit breaker. This has the particular advantage that there is a novel architecture in conjunction with the approval according to the invention, which opens up novel functionalities.

In an advantageous embodiment of the invention, the mechanical break contact unit is designed in such a manner that the at least one contact can be opened by the control unit, but not closed.

This has the particular advantage that increased operational reliability is achieved, as the contacts cannot inadvertently be closed by the control unit.

In an advantageous embodiment of the invention, the mechanical break contact unit is designed in such a manner that position information about the closed or open state of the at least one contact is available. Specifically, the position information can be detected by the control unit. A position sensor can be provided for this. The position sensor can be connected to the control unit.

This has the particular advantage that the control unit receives feedback about the switch position of the contacts or the handle, in order therefore to possibly make a further decision for an approval signal.

In an advantageous embodiment of the invention, a current sensor unit is provided for determining the level of the current of the low-voltage circuit. The current sensor unit is connected to the control unit. In particular, the current sensor unit is provided in a phase wire of the low-voltage circuit.

This has the particular advantage that there is a determination of the level of the current. In particular, due to the arrangement in the phase wire, in addition to overcurrents in the low-voltage circuit, overcurrents with respect to ground can also be detected.

In an advantageous embodiment of the invention, the approval signal is output to enable the closing of the at least one contact (by means of the handle) by the control unit. The approval signal is then output if the circuit breaker is in an operational state. This is the case in particular if the control unit is in an active and operational state and the control unit, the units or components (device parts) which are relevant for the protective function, such as electronic interrupt unit, current and voltage sensor units, are in an operational state.

This has the particular advantage that closing of the contacts is only possible if the circuit breaker can monitor the low-voltage circuit. Thus, increased protection or increased (operational) reliability is achieved.

In an advantageous embodiment of the invention, the at least one contact is opened by the control unit if a fault state is determined by the control unit.

This has the particular advantage that a safe state is produced both in the case of faults in the circuit and in the case of faults in the circuit breaker.

In an advantageous embodiment of the invention, the circuit breaker, particularly the mechanical break contact unit, has an actuator. The actuator, in the in particular de-energized state (or idle state), prevents closing of the at least one contact by the handle. If the approval signal is applied, i.e. in the in particular energized state, the actuator makes it possible for the at least one contact to be closed by the handle.

This has the particular advantage that, in the de-energized or idle state, a safe state of the circuit breaker always exists.

In an advantageous embodiment of the invention, the circuit breaker, particularly the mechanical break contact unit, is configured in such a manner that the handle can be moved if the approval signal is missing. The at least one contact cannot be closed here however.

This has the particular advantage that a freewheeling mechanism or permanent slider contact is provided, so that even in the event of (excessive) action of force on the handle, closing of the contacts is avoided (prevented).

In embodiment of an advantageous the invention, the electronic interrupt unit can be switched by semiconductor-based switching elements into a high-resistance state of the switching elements for avoiding a current flow or a low-resistance state of the switching elements for current flow in the low-voltage circuit.

This has the particular advantage that there is arc-free switching of the electrical circuit.

In an advantageous embodiment of the invention, the low-voltage circuit is a three-phase AC circuit. The circuit breaker has further terminals, between which one series connection of a further contact of the mechanical break contact unit and one electronic interrupt unit is connected in each case.

This has the particular advantage that there is a solution for three-phase AC circuits.

In an advantageous embodiment of the invention:
when contacts of the mechanical break contact unit are closed and the interrupt unit is low-resistance, and
when a current is determined, which exceeds a first current value, in particular in that the first current value is exceeded for a first time limit, the electronic interrupt unit becomes high-resistance and the mechanical break contact unit (MK) stays closed,
when a current is determined, which exceeds a second current value, in particular for a second time limit, the electronic interrupt unit becomes high-resistance and the mechanical break contact unit (MK) is opened,
when a current is determined, which exceeds a third current value, the electronic interrupt unit becomes high-resistance and the mechanical break contact unit (MK) is opened.

This has the particular advantage that there is a graded switch-off concept for the circuit breaker according to the invention.

In an advantageous embodiment of the invention, the control unit has a microcontroller.

This has the particular advantage that the functions according to the invention for increasing the safety of a circuit breaker or the electrical low-voltage circuit which is to be protected can be realized by a (customizable) computer program product. Furthermore, changes and improvements of the function can as a result be loaded onto a circuit breaker individually.

All embodiments, both in dependent form referring back to patent claim 1 and also referring back only to individual features or feature combinations of patent claims, effect an improvement of a circuit breaker, particularly an increase and improvement of the safety of a circuit breaker or the electrical circuit, and provide a novel concept for a circuit breaker.

The described properties, features and advantages of this invention and the manner in which these are achieved become clearer and more clearly understandable in connection with the following description of the exemplary embodiments that are explained in more detail in connection with the drawing.

In the drawing:

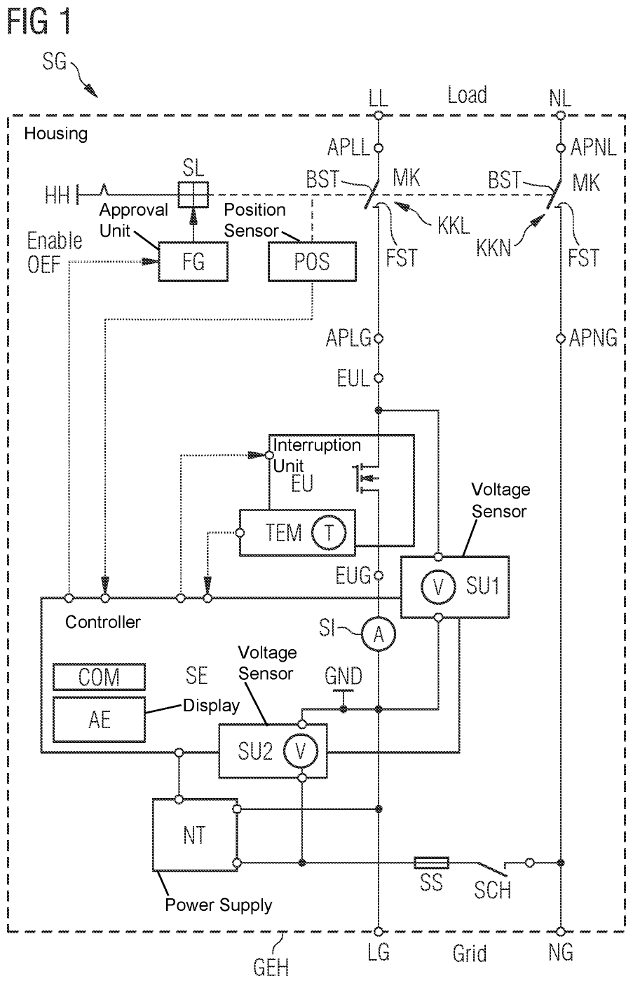

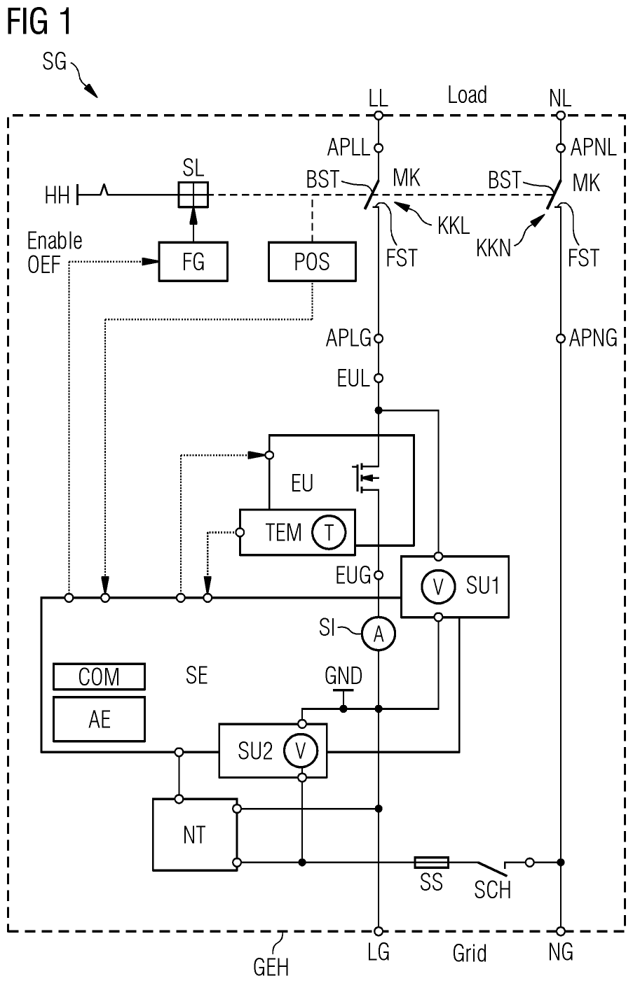

FIG. 1 shows a first schematic illustration of a circuit breaker,

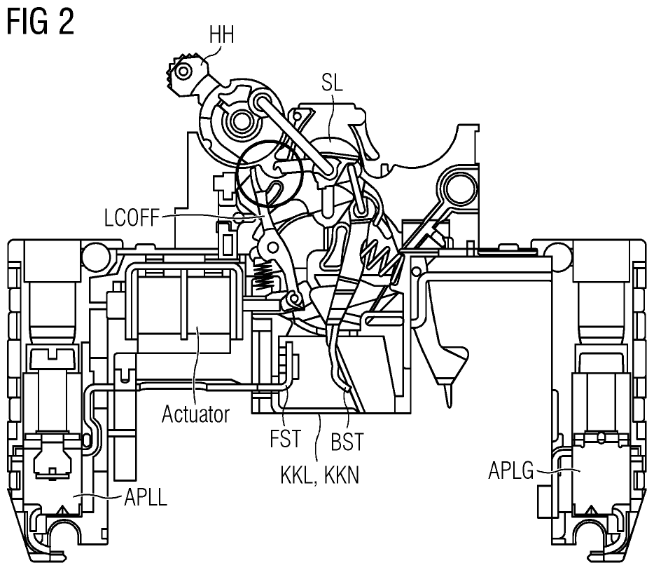

FIG. 2 shows a first illustration of a mechanical break contact unit,

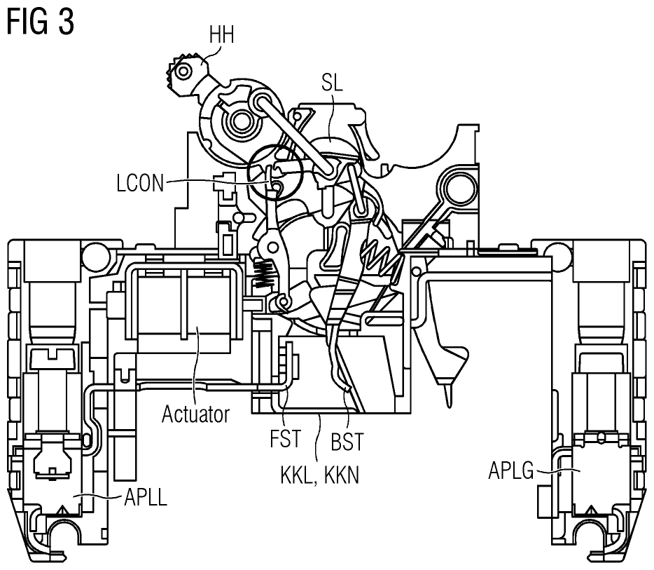

FIG. 3 shows a second illustration of a mechanical break contact unit,

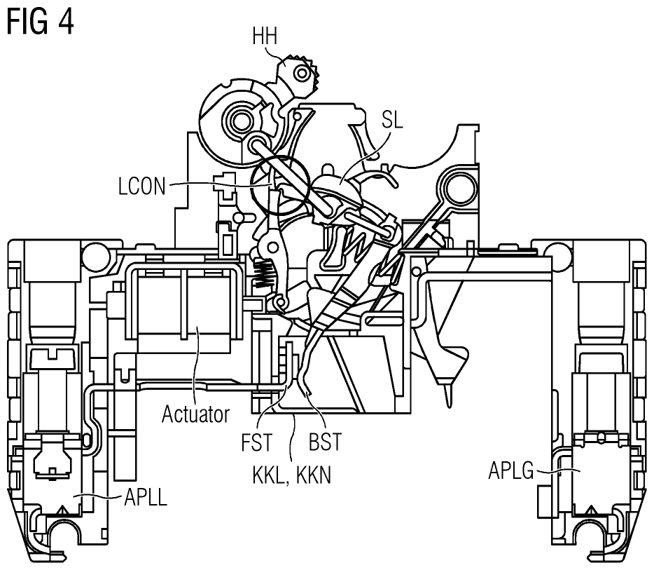

FIG. 4 shows a third illustration of a mechanical break contact unit,

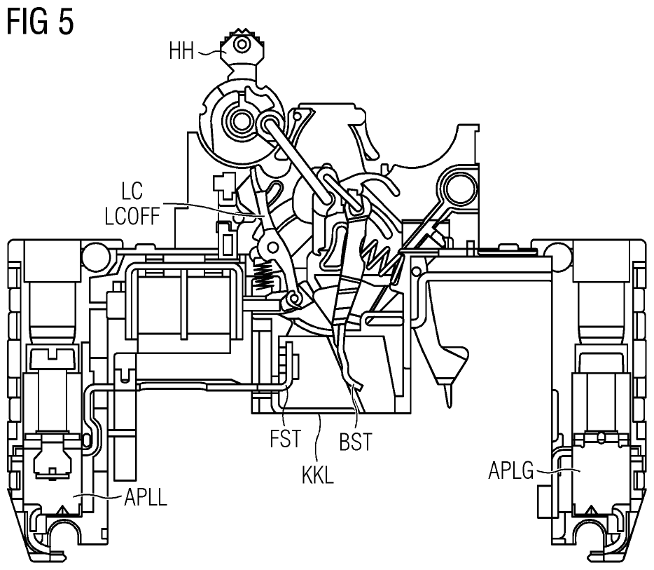

FIG. 5 shows a fourth illustration of a mechanical break contact unit.

FIG. 1 shows an illustration of a circuit breaker SG for protecting an electrical low-voltage circuit, in particular low-voltage AC circuit, having a housing GEH, having:
grid-side terminals which, in operation, comprise a grid-side neutral wire terminal NG and a grid-side phase wire terminal LG,
load-side terminals which, in operation, comprise a load-side neutral wire terminal NL and a load-side phase wire terminal LL,
the terminals are provided for the low-voltage circuit;
an energy source is usually connected at the grid-side terminals/the grid side GRID,
a consumer is usually connected at the load-side terminals/the load side LOAD;
a (two-pole) mechanical break contact unit MK having load-side terminal points APLL, APNL and grid-side terminal points APLG, APNG,
wherein a load-side terminal point APNL is provided for the neutral wire, a load-side terminal point APLL is provided for the phase wire, a grid-side terminal point APNG is provided for the neutral wire, a grid-side terminal point APLG is provided for the phase wire. The load-side terminal points APNL, APLL are connected to the load-side neutral and phase wire terminals NL, LL, so that it is possible to engage an opening of contacts KKN, KKL to avoid a current flow or a closing of the contacts for a current flow in the low-voltage circuit,
an, in particular single-pole, electronic interrupt unit EU, (which in the single-pole design is arranged in the phase wire in particular),
having a grid-side connecting point EUG which is in electrical connection with the grid-side phase wire terminal LG, and
a load-side connecting point EUL which is in electrical connection with or is connected to the grid-side terminal point APLG of the mechanical break contact unit MK, wherein, due to indicated semiconductor-based switching elements, the electronic interrupt unit EU has or can be switched to a high-resistance state of the switching elements for avoiding a current flow or a low-resistance state of the switching elements for current flow in the low-voltage circuit,
a current sensor unit SI for determining the level of the current of the low-voltage circuit, which is arranged in the current path of the phase wire or phase wire current path in particular,
a control unit SE which is connected to the current sensor unit SI, the mechanical break contact unit MK and the electronic interrupt unit EU, wherein interruption of the current flow in the low-voltage circuit is initiated by the mechanical break contact unit MK or/and the electronic interrupt unit EU if current or current/time limit values are exceeded.

Generally, the mechanical break contact unit MK is connected in series with the electronic interrupt unit EU. The mechanical break contact unit MK has a handle HH for opening at least one contact, in the example two contacts: a (first) phase wire contact KKL (for the phase wire) and a neutral wire contact KKN (for the neutral wire), for avoiding a current flow or closing the at least one contact for a current flow in the low-voltage circuit.

The handle HH is accessible on the device and can be operated by a user or technician.

The mechanical break contact unit MK can, as illustrated, be arranged on the load side. The electronic interrupt unit EU can be arranged on the grid side.

The grid side GRID having the energy source is normally electrically live. An electrical consumer is usually connected at the load side LOAD.

The mechanical break contact unit MK can be operated by the mechanical handle HH on the circuit breaker SG, in order to engage a manual opening or a closing of the contacts KKL, KKN. The mechanical handle HH indicates the switching state (open or closed) of the contacts of the mechanical break contact unit MK on the circuit breaker. Furthermore, the contact position (or the position of the handle, closed or open) can be transmitted to the control unit SE. The contact position (or the position of the handle) can be determined e.g. by means of a (position) sensor POS or position sensor unit POS. The contact position or the switching state can be transmitted to the control unit SE. This is indicated by an arrow from the position sensor unit POS to the control unit SE.

According to the invention, the mechanical break contact unit MK is advantageously designed in such a manner that a (manual) closing of the contacts by the mechanical handle HH is only possible after an approval (Enable), particularly an approval signal. The transmission of the approval or the approval signal is indicated by an arrow from the control unit SE to the mechanical break contact unit MK, particularly to an approval unit FG. That is to say, the at least one contact (in operation, the contacts KKL, KKN) of the mechanical break contact unit MK can only be closed by the handle HH if the approval or the approval signal (from the control unit) is present. Without the approval or the approval signal, although the handle HH can be actuated, the contacts are not closed (“permanent slider contacts”).

The approval unit/approval function FG effects an approval of the actuation of the contacts of the mechanical break contact unit by the handle HH if an approval signal Enable is present. That is to say, closing of the contacts KKL, KKN by the handle is only possible if the approval signal Enable (from the control unit SE) is present. Otherwise, closing is not possible (permanent sliding of the handle HH). The contacts remain in the open position/switching state.

Furthermore, the approval unit FG can effect an opening of the contacts (second function of the approval unit FG) if an opening signal OEF (from the control unit SE) is present. The approval unit/approval function FG then acts as a trip unit for opening the contacts of the mechanical break contact unit MK.

If a fault case or fault state occurs in the present electronics (control unit or/and electronic interrupt unit), the circuit breaker detects the fault and switches the device to a safe state. Likewise, a fault state on the load side LOAD or grid side GRID can be detected and lead to the switching of the device to a safe state.
a) The fault in the electronics is detected.
b) The device switches the power semiconductor off (high-resistance).
c) The device opens the mechanical break contact. A possible breaker latching mechanism of the mechanical break contact unit MK is then in an off state and switching on by means of the mechanical actuation/handle is no longer possible, as there is no approval signal present.
d) The fault case is reported via the communication unit COM.

Likewise, the circuit breaker can, as soon as it is supplied with electrical energy, test whether it is operational. For example by a self-test. If the test is completed positively, i.e. no faults of the device or the connected grid/energy source on the grid side GRID or the connected consumer on the load side LOAD are determined, i.e. the device is an active and operational state or/and environment, an approval signal Enable is only then output to the approval unit FG or mechanical break contact unit MK.

The circuit breaker SG can advantageously be designed in such a manner that the contacts of the mechanical break contact unit MK can be opened, but not closed by the control unit SE. The opening operation is likewise indicated by the arrow from the control unit SE to the mechanical break contact unit MK, with the operation OEF. Thus, the safety is increased further.

The circuit breaker can be designed in such a manner that the level of the voltage can advantageously be determined across the electronic interrupt unit. That is to say, the level of a first voltage between grid-side connecting point EUG and load-side connecting point EUL of the electronic interrupt unit EU can be or is determined.

To this end, in the example according to FIG. 1, a first voltage sensor unit SU1 is provided, which is connected to the control unit SE and which determines the level of the voltage between grid-side connecting point EUG and load-side connecting point EUL of the electronic interrupt unit EU.

In the voltage measurement by the first voltage sensor unit SU1, the voltage can alternatively also be determined across the series circuit of electronic interrupt unit EU and current sensor SI, as illustrated in FIG. 1. The current sensor unit SI has a very low internal resistance, so the determination of the level of the voltage is not impaired or is impaired to a negligible extent.

Advantageously, a second voltage sensor unit SU2 can be provided, which determines the level of the voltage between grid-side neutral wire terminal NG and grid-side phase wire terminal LG.

In the example according to FIG. 1, the electronic interrupt unit EU is realized in a single-pole manner, in the phase wire in the example. Here, the grid-side terminal point APNG for the neutral wire of the mechanical break contact unit MK is connected to the grid-side neutral wire terminal NG of the housing GEH.

The circuit breaker SG has an energy supply or power supply unit NT, for example a switched-mode power supply. In particular, the energy supply/power supply unit NT is provided for the control unit SE, which is indicated in FIG. 1 by a connection between energy supply/power supply unit NT and control unit SE. The energy supply/power supply unit NT is connected (on the other side) to the grid-side neutral wire terminal NG and the grid-side phase wire terminal LG. A fuse SS, particularly a melting fuse, or a switch SCH can advantageously be provided in the connection for the grid-side neutral wire terminal NG (or/and phase wire terminal LG).

The power supply unit NT is normally constantly supplied with energy in this embodiment. It is possibly protected by the fuse SS or can be switched off by the switch SCH.

The low-voltage circuit may be a three-phase AC circuit having a neutral wire and three phase wires. For this, the circuit breaker can be designed as a three-phase variant and for example have further grid-side and load-side phase wire terminals. In each case, electronic interrupt units and contacts of the mechanical break contact unit according to the invention, likewise current sensor units, are provided in an analogous manner between the further grid-side and load-side phase wire terminals. Furthermore, voltage determination (e.g. by first voltage sensor units) may be provided.

The circuit breaker SG may have a temperature sensor TEM for determining the level of the temperature of the circuit breaker or in particular for determining the level of the temperature of the electronic interrupt unit EU, as indicated in FIG. 1. The temperature sensor TEM is connected to the control unit SE. If a temperature limit value is exceeded, an opening signal OEF can be output or an approval signal cannot be output/can be prevented.

The circuit breaker SG can have a display unit AE for displaying information, switching states, etc. of the circuit breaker. The display unit AE is connected to the control unit SE or may be part of the control unit SE.

The circuit breaker SG may have a communication unit COM. The communication unit COM is connected to the control unit SE or may be part of the control unit SE. The communication unit COM may be a wired communication unit or preferably wireless communication unit, for example a radio-based communication unit.

High-resistance means a state in which only a current of insignificant size still flows. A current of insignificant size in particular means a current with a level of less than 2 mA, more specifically of less than 0.5 mA.

In particular, high-resistance means resistance values of greater than 1 kilohm, better greater than 10 kilohms, 100 kilohms, 1 megohm, 10 megohms, 100 megohms, 1 gigaohm or greater.

Low-resistance means a state in which the current value indicated on the circuit breaker could flow. In particular, low-resistance means resistance values which are less than 10 ohms, better less than 1 ohm, 100 milliohms, 10 milliohms, milliohm or less.

The circuit breaker according to FIG. 1 can be constructed in two parts. For example, having an electronic first part, for example on a printed circuit board. The first part May have the control unit SE, the first voltage sensor unit SU1, the second voltage sensor unit SU2, the current sensor unit SI, the electronic interrupt unit EU, the energy supply NT. Furthermore, the first part can have the melting fuse SS, the switch SCH, the temperature sensor TEM (in particular for the electronic interrupt unit EU), the communication unit COM, the display unit AE.

The first part can to this end have only three terminals:
the grid-side phase wire terminal LG,
a terminal for the or to the grid-side phase wire terminal point APLG of the mechanical break contact unit MK,
a terminal for a connection for the neutral wire terminal NG.

The circuit breaker can then further contain a, particularly mechanical, second part. The second part may have the mechanical break contact unit MK, the handle HH, the approval unit FG. Furthermore, the second part may have the position unit POS for reporting the position of the contacts of the mechanical break contact unit MK to the control unit, and also the (neutral wire) connection(s). Further units which are not mentioned in any more detail may be provided.

Due to the division in two, a compact circuit breaker according to the invention can advantageously be realized.

In other words, FIG. 1 shows the overview of the components in the (electronic) circuit breaker. The circuit breaker has a mechanical break contact unit MK and an electronic interrupt unit EU (electronic switch). Furthermore, a control unit SE is contained. The control unit SE detects measured values of the sensor unit. The control unit SE controls the electronic interrupt unit. The control unit SE controls the approval unit FG of the mechanical break contact unit.

The contacts of the mechanical break contact unit can only be closed by the handle/mechanical actuation.

An e.g. breaker latching mechanism SL of the mechanical break contact unit MK is thus designed such that the closing of the contacts KKL, KKN is not possible by manual actuation using the handle HH/at the switching lever that is present, as long as the control unit SE does not explicitly approve this (approval signal Enable). Thus, it is ensured that the contacts can only be closed (by manual actuation) if the control unit SE is active and has checked its functionality.

The following methods can be used for checking the functionality:
checking the electronic interrupt unit EU,
checking the voltage supply (voltage sensor units SU1, SU2; exceeding or falling below voltage threshold values)
checking the mains voltage (exceeding or falling below voltage threshold values)
checking the temperature (exceeding temperature threshold values)
etc.

Furthermore, the control unit SE can send an opening signal OEF to the mechanical break contact unit MK, in order to open the contacts in the closed state, for example likewise by means of the approval unit FG. The contacts or mechanical break contacts can therefore be brought from the closed state into the open state by the control unit SE.

FIG. 2 shows, at least as a detail or indication, the structure or components of a mechanical break contact unit MK, in particular having a breaker latching mechanism SL, the handle HH and the contact KKL (in the case of arrangement in the phase wire) or KKN (in the case of arrangement in the neutral wire). In operation, the contact has a contact member pair, consisting of a fixed contact member FST and a moved contact member BST (moving contact member). An actuator “Actuator” according to the invention is provided, for example a relay coil with tappet, which engages into the mechanical break contact unit MK or is provided in the mechanical break contact unit MK, as drawn for example in FIG. 2. The actuator “Actuator” prevents a closing of the at least one contact by the handle, in the e.g. advantageously de-energized state, from being prevented. That is to say, the actuator is correspondingly arranged or engages correspondingly into the mechanical break contact unit MK or the breaker latching mechanism SL.

The actuator “Actuator” further causes the actuator to be energized if the approval signal is applied, so the at least one contact can be closed by the handle. That is to say, the actuator “Actuator” is correspondingly arranged or engages correspondingly into the mechanical break contact unit MK or the breaker latching mechanism SL.

FIG. 2 shows the switched-off state of the mechanical break contact unit MK with open contacts KKL (or KKN). The actuator “Actuator” interacts with a lever LC (lock-control lever). In FIG. 2, the lever LC or lock-control lever is located in a “disabled” position LCOFF, so switching on of the mechanical contact is not possible. Actuation of the handle HH would lead to sliding through and the contacts or the moving contact of the at least one contact pair remain in the illustrated (switched-off/high-resistance) open position. Mechanically, the approval function is realized by the lever LC (in the switched-off position: LCOFF) and the actuator “Actuator”.

FIG. 3 shows an illustration according to FIG. 2, in which the contact KKL (or KKN) is (likewise) in the switched-off/open position, with the difference that the lever LC or lock-control lever is in an “enable” position LCON, which enables closing or switching on of the contacts by the handle HH. For this, the lever LC or lock-control lever was moved by means of the actuator “Actuator” into a different position, so that there may be a latching with the breaker latching mechanism during actuation of the handle for closing the contacts (switching on), so that the movable contact member BST (moving contact member) can come into contact with the fixed contact member FST of the contact and the contact can be closed.

FIG. 4 shows an illustration according to FIG. 3, with the difference that the handle HH was actuated. The contact could be closed. The latching of the elements is illustrated. The contacts are located in the closed position.

FIG. 5 shows an illustration according to FIG. 2, with the difference that the handle HH was actuated. As the actuator was not energized (no approval or no approval signal Enable), the handle cannot grip the breaker latching mechanism and consequently cannot close the contact. The handle can be moved, but the contact cannot be closed. After actuation, the handle returns back to the original state (slider contact or permanent slider contact).

According to the invention, a novel component and novel practical arrangement of all necessary components for a circuit breaker are proposed.

A novel electronic circuit breaker having mechanical break contact units in combination with an electronic switch is proposed. In the event of a defect in the circuit breaker, particularly in the control unit SE or electronic interrupt unit EU, the manual mechanical switching-on of the break contacts is prevented. Thus, safe operation of the circuit breaker is always ensured.

Although the invention was illustrated and described in more detail by the exemplary embodiment, the invention is not limited by the disclosed examples and other variations can be deduced from this by a person skilled in the art without departing from the protective scope of the invention.

1-14. (canceled)

15. A circuit breaker for protecting an electrical low-voltage circuit, the circuit breaker comprising:
an electronic interruption unit;
a mechanical break contact unit connected in series with said electronic interruption unit, said mechanical break contact unit having contacts and a handle for opening at least one of said contacts for avoiding a current flow or closing said at least one contact for allowing the current flow in the electrical low-voltage circuit;
a controller connected to said mechanical break contact unit and said electronic interruption unit; and
the circuit breaker is configured such that interruption of the current flow in the electrical low-voltage circuit is initiated by said mechanical break contact unit and/or said electronic interruption unit when current or current/time limit values are exceeded, the circuit breaker is configured such that said at least one contact of said mechanical break contact unit can only be closed by said handle if an approval signal for closing said at least one contact is present.

16. The circuit breaker according to claim 15, further comprising:
a load-side terminal connected to said mechanical break contact unit; and
a grid-side terminal connected to said electronic interrupt unit.

17. The circuit breaker according to claim 15, wherein said mechanical break contact unit is configured such that said at least one contact can be opened by said controller, but not closed.

18. The circuit breaker according to claim 15, wherein said mechanical break contact unit is configured such that position information about a closed or open state of said at least one contact is available.

19. The circuit breaker according to claim 15, further comprising a current sensor for determining a level of a current of the electrical low-voltage circuit and being connected to said controller.

20. The circuit breaker according to claim 15, wherein the approval signal is output to enable the closing of said at least one contact, by means of said handle, by said controller.

21. The circuit breaker according to claim 15, wherein said at least one contact is opened by said controller if a fault state is determined by said controller.

22. The circuit breaker according to claim 15, further comprising an actuator, which:
prevents closing of said at least one contact by said handle in a de-energized state; and
is energized if the approval signal is applied, so said at least one contact is closeable by said handle.

23. The circuit breaker according to claim 15, wherein if the approval signal is missing, said handle moves, but said at least one contact cannot be closed.

24. The circuit breaker according to claim 15, wherein said electronic interruption unit has semiconductor-based switching elements and is switched into a high-impedance state of said semiconductor-based switching elements for avoiding the current flow or a low-impedance state of said semiconductor-based switching elements for the current flow in the electrical low-voltage circuit.

25. The circuit breaker according to claim 15, wherein:
said electronic interruption unit is one of a plurality of electronic interruption units;
the electrical low-voltage circuit is a three-phase AC circuit; and
the circuit breaker has further terminals, between said further terminals a series connection of a further contact of said mechanical break contact unit and one of said electronic interrupt units is connected in each case.

26. The circuit breaker according to claim 15, wherein if said contacts of said mechanical break contact unit are closed and said electronic interruption unit is in a low-impedance state, and:
if a current is determined, which exceeds a first current value, said electronic interruption unit assumes a high-impedance state and said mechanical break contact unit stays closed;
if a current is determined, which exceeds a second current value, said electronic interruption unit assumes the high-impedance state and said mechanical break contact unit is opened; and
if a current is determined, which exceeds a third current value, said electronic interruption unit assumes the high-impedance state and said mechanical break contact unit is opened.

27. The circuit breaker according to claim 15, wherein said controller has a microcontroller.

28. The circuit breaker according to claim 18, wherein the position information is detected by said controller.

29. The circuit breaker according to claim 15, wherein the approval signal is output to enable the closing of said at least one contact, by means of said handle, by said controller, if said controller is in an active state and has determined a functionality of the circuit breaker by checking at least one unit of the circuit breaker.

30. The circuit breaker according to claim 26, wherein:
the first current value is exceeded for a first time limit; and
the second current value is exceeded for a second time limit.

31. A mechanical break contact unit for a circuit breaker, said mechanical break contact unit comprising:
a handle; and
at least one contact being closed by said handle, said at least one contact can only be closed if an approval signal is present.
